(19) United States
(12) Patent Application Publication
(10) Pub. No.: US 2015/0130966 A1
(43) Pub. Date: May 14, 2015

(54) IMAGE FORMING METHOD AND APPARATUS, AND ELECTRONIC DEVICE

(71) Applicant: SONY CORPORATION, Tokyo (JP)

(72) Inventor: Qing YANG, Beijing (CN)

(73) Assignee: SONY CORPORATION, Tokyo (JP)

(21) Appl. No.: 14/250,827

(22) Filed: Apr. 11, 2014

(30) Foreign Application Priority Data
Nov. 14, 2013 (CN) 201310566005.6

(51) Int. Cl. H04N 5/232

(52) U.S. Cl. CPC H04N 5/23212; H04N 5/23222
USPC 348/231.6

(57) ABSTRACT

The embodiments of the present invention provide an image forming method and apparatus, and an electronic device. The image forming method includes: matching a real-time image formed by an image forming element with a pre-stored registered image, when a depth of field of the image forming element moves; and making a shooting when an object corresponding to the registered image is matched with an object in the real-time image and the object is within the depth of field of the image forming element. With the embodiments of the present invention, an accurate auto-focusing can be achieved, an effect of highlighting a specific object and clearly imaging the same can be obtained, and an image of higher quality can be formed.

### CROSS-REFERENCE TO RELATED APPLICATION AND PRIORITY CLAIM

This application claims priority from Chinese patent application No. 201310566005.6, filed Nov. 14, 2013, the entire disclosure of which hereby is incorporated by reference.

### TECHNICAL FIELD

The present invention relates to an image processing technology, and particularly, to an image forming method and apparatus, and an electronic device.

### BACKGROUND

With the popularization of portable electronic devices (e.g., smart phone, digital camera, tablet computer, handheld gaming device, etc.), it is increasingly easier to shoot images or videos. Usually the portable electronic device is provided with a camera to shoot an object in a mode such as auto-focusing.

Currently, a principle of imaging with a reflected light of an object may be employed in a focusing process of the camera, wherein the reflected light is received by a sensor on the electronic device, such as a Charge Coupled Device (CCD) sensor or a Complementary Metal Oxide Semiconductor (CMOS) sensor, and then processed by a software program to drive a electric focusing apparatus.

To be noted, the above introduction to the technical background is just made for the convenience of clearly and completely describing the technical solutions of the present invention, and to facilitate the understanding of a person skilled in the art. It shall not be deemed that the above technical solutions are known to a person skilled in the art just because they have been illustrated in the Background section of the present invention.

### SUMMARY

However, the inventor finds that in certain cases, an ideal image cannot be obtained since the focusing is inaccurate. For example, when an object in crowd at a scenic spot is shot, faces other than the object are not the images hoped to be obtained or highlighted. If the shooting is made in the current auto-focusing mode, the object cannot be accurately focused, and an image of higher quality cannot be obtained.

Or, for example, in a case where a video recording is made using a portable electronic device in a meeting room or a classroom where there are many people, if the current auto-focusing function is employed, the depth of field may hop in a disorderly manner and cause the display screen to dither seriously, since the lens recognizes and focuses faces in different depths of field.

The embodiments of the present invention provide an image forming method and apparatus, and an electronic device, so as to focus the object accurately to obtain an image of higher (e.g., improved) quality.

According to a first aspect of the embodiments of the present invention, an image forming method is provided, including:

matching a real-time image formed by an image forming element with a pre-stored registered image, when a depth of field of the image forming element moves; and making a shooting when an object corresponding to the registered image is matched with an object in the real-time image and the object is within the depth of field of the image forming element.

According to a second aspect of the embodiments of the present invention, by using a focusing apparatus, the depth of field of the image forming element is controlled to move from near to far, or move to-and-fro between proximal and distal ends.

According to a third aspect of the embodiments of the present invention, an image formed by the shooting is a static image or a dynamic image.

According to a fourth aspect of the embodiments of the present invention, the image forming method further includes: obtaining the registered image by shooting the object, or obtaining the registered image transmitted from another device via a communication interface.

According to a fifth aspect of the embodiments of the present invention, the image forming method further includes: performing an image processing for an image formed by the shooting.

According to a sixth aspect of the embodiments of the present invention, an image forming apparatus is provided, including:

an image matching unit configured to match a real-time image formed by an image forming element with a pre-stored registered image, when a depth of field of the image forming element moves; and

an image shooting unit configured to make a shooting when an object corresponding to the registered image is matched with an object in the real-time image and the object is within the depth of field of the image forming element.

According to a seventh aspect of the embodiments of the present invention, the image forming apparatus further includes:

an image registering unit configured to obtain the registered image by shooting the object, or obtain the registered image transmitted by another device via a communication interface.

According to an eighth aspect of the embodiments of the present invention, the image forming apparatus further includes:

an image processing unit configured to perform an image processing for an image formed by the shooting.

According to a ninth aspect of the embodiments of the present invention, an electronic device is provided, including:

an image forming element having a depth of field;

a focusing apparatus configured to control the depth of field of the image forming element to move; and

the aforementioned image forming apparatus.

According to a tenth aspect of the embodiments of the present invention, the focusing apparatus controls the depth of field of the image forming element from near to far, or move to-and-fro between proximal and distal ends.

The embodiments of the present invention have one or more of the following beneficial effects: in the focusing process the real-time image formed by the image forming element is matched with the pre-stored registered image, and the shooting is made when the object corresponding to the registered image is matched with the object in the real-time image and the object is within the depth of field of the image forming element. Thus an accurate focusing can be achieved, an effect of highlighting the object can be obtained, and an image of higher quality can be formed.

These and other aspects of the present invention will be clear with reference to the subsequent descriptions and drawings, which specifically disclose the particular embodiments of the present invention to indicate some implementations of the principles of the present invention. But it shall be appreciated that the scope of the present invention is not limited thereto, and the present invention includes all the changes, modifications and equivalents falling within the scope, spirit and the connotations of the accompanying claims.

Features described and/or illustrated with respect to one embodiment can be used in one or more other embodiments in a same or similar way, and/or by being combined with or replacing the features in other embodiments.

To be noted, the term “comprise/include” used herein specifies the presence of feature, element, step or component, not excluding the presence or addition of one or more other features, elements, steps or components or combinations thereof.

Many aspects of the present invention will be understood better with reference to the following drawings. The components in the drawings are not necessarily drafted in proportion, and the emphasis lies in clearly illustrating the principles of the present invention. For the convenience of illustrating and describing some portions of the present invention, corresponding portions in the drawings may be enlarged, e.g., being more enlarged relative to other portions than the situation in the exemplary device practically manufactured according to the present invention. The parts and features illustrated in one drawing or embodiment of the present invention may be combined with the parts and features illustrated in one or more other drawings or embodiments. In addition, the same reference signs denote corresponding portions throughout the drawings, and they can be used to denote the same or similar portions in more than one embodiment.

### BRIEF DESCRIPTION OF THE DRAWINGS

The included drawings provide further understanding of the present invention, and they constitute a part of the Specification. The drawings illustrate the preferred embodiments of the present invention, and explain the principles of the present invention together with the text, wherein the same element is denoted with the same reference sign.

In which:

FIG. 1 is a flowchart of an image forming method according to an embodiment of the present invention;

FIG. 2 is another flowchart of an image forming method according to an embodiment of the present invention;

FIG. 3 is a schematic diagram of an image shot in an auto-focusing mode in the relevant art;

FIG. 4 is a schematic diagram of a registered image according to an embodiment of the present invention;

FIG. 5 is a schematic diagram of a shot image according to an embodiment of the present invention;

FIG. 6 is another schematic diagram of a shot image according to an embodiment of the present invention;

FIG. 7 is a structure diagram of an image forming apparatus according to an embodiment of the present invention; and

FIG. 8 is a block diagram of a system structure of an electronic device according to an embodiment of the present invention.

### DESCRIPTION OF THE EMBODIMENTS

The interchangeable terms “electronic device” and “electronic apparatus” include a portable radio communication device. The term “portable radio communication device”, which is hereinafter referred to as “mobile radio terminal”, “portable electronic apparatus”, or “portable communication apparatus”, includes all devices such as mobile phone, pager, communication apparatus, electronic organizer, personal digital assistant (PDA), smart phone, media player, tablet computer, portable communication apparatus, portable gaming device, etc.

In the present application, the embodiments of the present invention are mainly described with respect to a portable electronic apparatus in the form of a mobile phone (also referred to as “cellular phone”). However, it shall be appreciated that the present invention is not limited to the case of the mobile phone and it may relate to any type of appropriate electronic device, such as media player, portable gaming device, PDA, computer, digital camera, tablet computer, etc.

The image forming element (e.g., an optical element of a camera) has a depth of field. In the focusing process, the image forming element can form a clear object plane (e.g., a curved surface similar to a spherical surface) on the photosensitive plane (e.g., a plane where a sensor such as a CCD sensor or a CMOS sensor is located), thereby forming the depth of field. The object in the depth of field can form a clear image at the image forming element. The depth of field (or the object plane) may be driven by an electric focusing apparatus to move, for example from a proximal end (wide end or wide angle end) to a distal end (telephoto end). After one or several to-and-from movements, the object to be shot is clearly imaged, thus the focusing is completed and a clear image is obtained.

### Embodiment 1

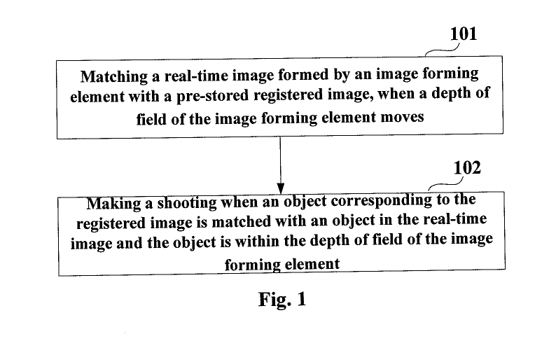

The embodiment of the present invention provides an image forming method. FIG. 1 is a flowchart of an image forming method according to an embodiment of the present invention. As illustrated in FIG. 1, the image forming method includes:

Step 101: matching a real-time image formed by an image forming element with a pre-stored registered image, when a depth of field of the image forming element moves;

Step 102: making a shooting when an object corresponding to the registered image is matched with an object in the real-time image and the object is within the depth of field of the image forming element.

Shooting may mean shooting an image or a video, or “taking” an image or a photo or a video, photographing or making a video, and so on. The registered image may be referred to as a reference image and is described further below. Also, examples of matching are described below.

In this embodiment, the image forming method may be implemented by an electronic device having an image forming element, and the image forming element may be integrated into the electronic device. For example, the image forming element may be a front camera of a smart phone. The electronic device may be a mobile terminal, such as a smart phone or a digital camera, but the present invention is not limited thereto. The image forming element may be a camera or a part thereof. In addition, the image forming element may also be a lens (e.g., lens of single lens reflex camera) or a part thereof. The present invention is not limited thereto, and please refer to the relevant art for the image forming element.

In addition, the image forming element may be removably integrated with the electronic device through an interface. In addition, the image forming element may be connected to the electronic device wiredly or wirelessly, such as being controlled by the electronic device by using WiFi, Bluetooth or Near Field Communication (NFC). The present invention is not limited thereto, and in other ways, the electronic device may also be connected to the image forming element such that the image forming element is controlled by the electronic device.

In this embodiment, a focusing apparatus may be used to control the movement of the depth of field of the image forming element, i.e., to control an object plane, where the image forming element forms an image clearly, to move. The depth of field (or object plane) may move from near to far, or move to-and-fro between the proximal and distal ends. In which, the focusing apparatus may include: a Voice Coil Motor (VCM) (including, but not limited to, a smart VCM, a conventional VCM, VCM2 or VCM3); a T-Lens; a piezo motor drive; a Smooth Impact Drive Mechanism (SIDM); a liquid actuator; or a focusing motor in other form. For the concept about the depth of field, the concept about the object plane where the image forming element forms an image clearly, and how the focusing apparatus makes the depth of field (or object plane) move, please refer to the relevant art, which are omitted herein.

In this embodiment, a registered image corresponding to an object may be pre-stored. For example, the object may be shot to obtain and store the registered image. Before an object in a crowd is shot, the face of the object is shot to obtain a face image of the object as the registered image. Or the object may be shot with the electronic device in advance (e.g., several days before) to store the image of the object as the registered image.

Or the registered image transmitted from another device is obtained via a communication interface and then stored. For example, the registered image may be obtained via E-mail, social software, etc., or by using Universal Serial Bus (USB), Bluetooth, NFC, etc. The present invention is not limited thereto, and any way of obtaining the registered image can be adopted.

In this embodiment, the registered image includes the image of the object, such as a face, a body, a pattern, a landscape or any other image. For convenience, the following description is only made through an example where the registered image includes the face, but the present invention is not limited thereto.

In this embodiment, the matching between the real-time image and the registered image may be performed using the relevant art. For example, the face in the registered image and the face in the real-time image may be recognized using face recognition technology, such as performing a mode recognition according to the facial features, to judge whether the face in the registered image and the face in the real-time image belong to the same person, and if yes, it is determined that the face in the registered image is matched with the face in the real-time image.

In addition, a matching threshold may be set, and when the matching similarity exceeds the threshold, it is determined that the object in the registered image is matched with the object in the real-time image. For example, the threshold may be preset as 80%. When the similarity between the face in the registered image and the face in the real-time image is recognized as 82% by using the face recognition technology, it is determined that the object in the registered image is matched with the object in the real-time image. When the similarity between the face in the registered image and the face in the real-time image is recognized as 42% by using the face recognition technology, it is determined that the object in the registered image is not matched with the object in the real-time image.

The matching between the real-time image and the registered image is exemplarily described as above, but the present invention is not limited thereto, and the specific matching mode may be determined according to the actual situation.

In the focusing process, when the depth of field of the image forming element moves, a matching between the real-time image formed by the image forming element and the pre-stored registered image is performed. When the object corresponding to the registered image is matched with the object in the real-time image and the object is within the depth of field of the image forming element, the depth of field of the image forming element may not move any more. In that case, a shooting may be made to form a shot image. In this way, the object corresponding to the registered image is within the depth of field, and a focusing is performed, thereby accurately focusing the object such that the object is clearly visible, while the surrounding objects may become vague because they are not accurately within the depth of field, thus an image of better quality can be obtained.

To be noted, the image forming method in the embodiment of the present invention is applicable to shooting both static images such as photographs, and dynamic images such as video images.

In this embodiment, after a shot image is formed in step 102, an image processing may be performed for the image formed by the shooting. For example, the shot image may be cropped to remove the portions around and place the object in the middle of the image; or the object may be further sharpened; or the brightness, saturation, white balance, etc. of the shot image or a part thereof may be adjusted. But the present invention is not limited thereto, and specific image processing may be determined according to the actual situation.

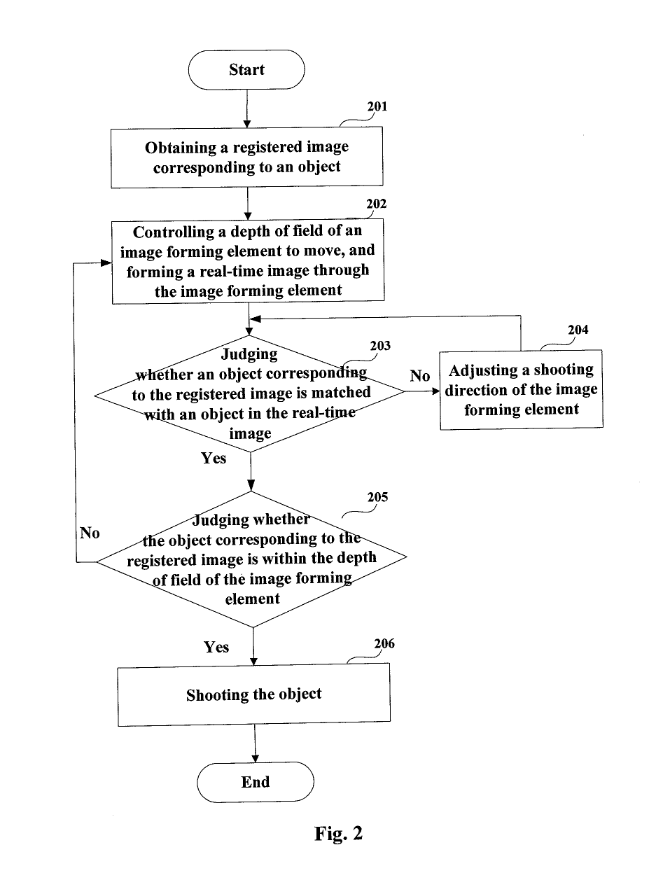

FIG. 2 is another flowchart of an image forming method according to an embodiment of the present invention. As illustrated in FIG. 2, the image forming method includes:

Step 201: obtaining a registered image corresponding to an object.

In this embodiment, the registered image may be obtained by directly shooting the object, or from another device through a network transmission.

Step 202: controlling a depth of field of an image forming element to move, and forming a real-time image by using the image forming element.

Step 203: matching the real-time image with the pre-stored registered image, and judging whether an object corresponding to the registered image is matched with an object in the real-time image; if yes, performing step 205, and if no, performing step 204.

In this embodiment, the matching between the real-time image and the registered image may be performed using the image recognition technology. For example, the face recognition technology may be used to determine whether the face in the registered image is matched with the face in the real-time image. Please refer to the relevant art for the matching or the image recognition.

Step 204: adjusting a shooting direction of the image forming element.

For example, the shooting direction of the image forming element may be adjusted by observing a liquid crystal display screen of the portable electronic device (e.g., a smart phone or a digital camera).

In addition, when the object in the registered image is not matched with the object in the real-time image, e.g., the object in the registered image does not appear in the real-time image, the electronic device may give an information prompt, for example sending a prompting message “the object is not matched”, thereby reminding the user to adjust the shooting direction of the image forming element.

Step 205: judging whether the object corresponding to the registered image is within the depth of field of the image forming element; if yes, performing step 206, and if no, continuing to perform step 202.

Step 206: shooting the object. After the shot image is obtained, an appropriate image processing may be performed.

In this embodiment, by matching the registered image with the real-time image in the focusing process, the object corresponding to the registered image can be accurately focused to obtain a better image. To be noted, FIG. 2 only schematically illustrates an example of the present invention, and the present invention is not limited thereto. For example, the orders of steps 203 and 205 may be adjusted. The specific embodiment may be determined according to the actual situation.

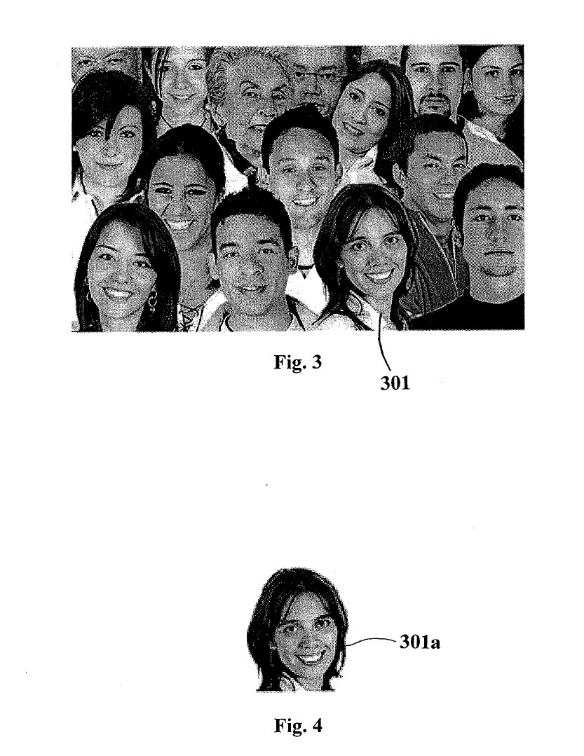

FIG. 3 is a schematic diagram of an image shot in an auto-focusing mode in the prior art. As illustrated in FIG. 3, since the focusing is not accurate, the object 301 and other faces are shot together and their definitions are close to each other, thus the object cannot be highlighted, and the image is not ideal.

FIG. 4 is a schematic diagram of a registered image according to an embodiment of the present invention. The registered image 301 is corresponding to the object 301 and it may be pre-stored.

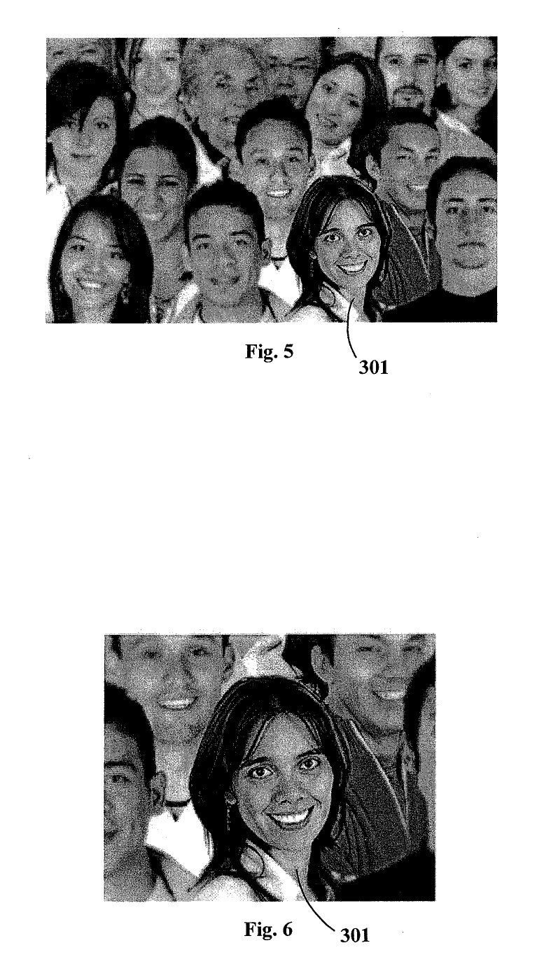

FIG. 5 is a schematic diagram of a shot image according to an embodiment of the present invention. As illustrated in FIG. 5, the shooting is made when the object corresponding to the registered image is within the depth of field of the image forming element, and the object 301 can be accurately focused. In the shot image, the object 301 is very clear while other faces are vague, thus an ideal image can be obtained.

FIG. 6 is another schematic diagram of a shot image according to an embodiment of the present invention, which illustrates the situation of placing the object 301 in the middle of the image by cropping FIG. 5. Thus the object is highlighted to obtain a better shooting effect.

To be noted, the present invention is just described as above through the examples of static images (pictures). But the present invention is not limited thereto, and for example it may also be applied to shoot the dynamic images (videos). By matching the registered image, the depth of field will not hop disorderly, and the video screen (e.g., display) will not dither seriously. In addition, a follow-focusing may be performed for the object in the video to highlight the object.

As can be seen from the above embodiment, in the focusing process the real-time image formed by the image forming element is matched with the pre-stored registered image, and the shooting is made when the object corresponding to the registered image is matched with the object in the real-time image and the object is within the depth of field of the image forming element. Thus an accurate focusing can be achieved, an effect of highlighting the object can be obtained, and an image of higher quality can be formed.

### Embodiment 2

The embodiment of the present invention provides an image forming apparatus, which is corresponding to the image forming method in Embodiment 1, and the same contents are omitted.

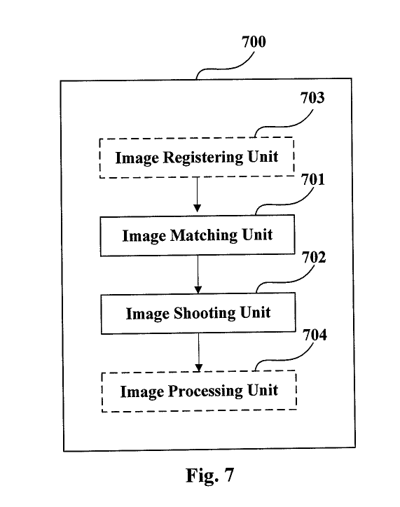

FIG. 7 is a structure diagram of an image forming apparatus according to an embodiment of the present invention. As illustrated in FIG. 7, an image forming apparatus 700 includes an image matching unit 701 and an image shooting unit 702. The image matching unit 701 matches a real-time image formed by an image forming element with a pre-stored registered image, when a depth of field of the image forming element moves; and the image shooting unit 702 makes a shooting when an object corresponding to the registered image is matched with an object in the real-time image and the object is within the depth of field of the image forming element.

In this embodiment, please refer to the relevant art for the image forming element. The image forming apparatus 700 may be a hardware apparatus or a software module, which is controlled by a Central Processing Unit (CPU) of the electronic device to implement the image forming method. But the present invention is not limited thereto, and the specific embodiment may be determined according to the actual situation.

As illustrated in FIG. 7, the image forming apparatus 700 may further include: an image registering unit 703 which obtains the registered image by shooting the object, or obtains the registered image transmitted by another device via a communication interface.

As illustrated in FIG. 7, the image forming apparatus 700 may further include: an image processing unit 704 which performs an image processing for the image formed by the shooting.

In this embodiment, the image forming apparatus 700 may further include: an information prompting unit (not illustrated) which gives an information prompt when the object corresponding to the registered image is not matched with the object in the real-time image.

As can be seen from the above embodiment, in the focusing process the real-time image formed by the image forming element is matched with the pre-stored registered image, and the shooting is made when the object corresponding to the registered image is matched with the object in the real-time image and the object is within the depth of field of the image forming element. Thus an accurate focusing can be achieved, an effect of highlighting the object can be obtained, and an image of higher quality can be formed.

### Embodiment 3

The embodiment of the present invention provides an electronic device, which controls an image forming element (e.g., camera, lens, etc.). The electronic device may be, but not limited to, a cellular phone, a photo camera, a video camera, a tablet computer, etc.

In this embodiment, the electronic device may include an image forming element, a focusing apparatus which controls a depth of field of the image forming element to move, and the image forming apparatus as described in Embodiment 2, which are incorporated herein, and the same contents are omitted.

In which, by using a Voice Coil Motor (VCM) (including, but not limited to, a smart VCM, a conventional VCM, VCM2 or VCM3), a T-Lens, a piezo motor drive, a Smooth Impact Drive Mechanism (SIDM), a liquid actuator, or a focusing motor in other form, the focusing apparatus controls an object plane, where the image forming element forms an image clearly, to move from near to far, or move to-and-fro between the proximal and distal ends.

In this embodiment, the electronic device may be, but is not limited to, a mobile terminal.

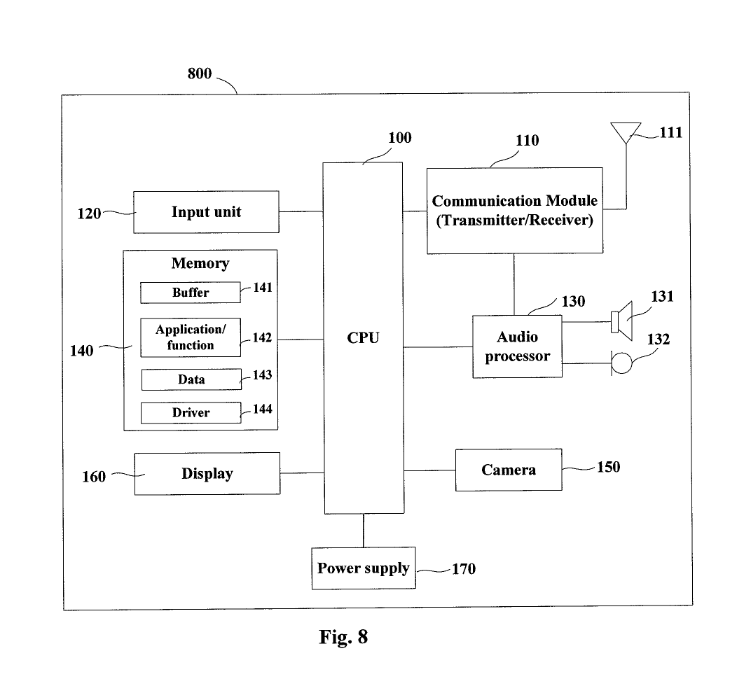

FIG. 8 is a block diagram of a system structure of an electronic device according to an embodiment of the present invention. The electronic device 800 may include a CPU 100 and a memory 140 coupled to the CPU 100. To be noted, the diagram is exemplary, and other type of structure may also be used to supplement or replace the structure, so as to realize the telecom function or other function.

In one embodiment, the function of the image forming apparatus 700 may be integrated into the CPU 100. In which, the CPU 100 may be configured to match a real-time image formed by an image forming element with a pre-stored registered image, when a depth of field of the image forming element moves; and make a shooting when an object corresponding to the registered image is matched with an object in the real-time image and the object is within the depth of field of the image forming element.

The CPU 100 may be further configured to control, by using a focusing apparatus, the depth of field of the image forming element to move from near to far, or move to-and-fro between proximal and distal ends. In which, the focusing apparatus may include: a Voice Coil Motor (VCM) (including, but not limited to, a smart VCM, a conventional VCM, VCM2 or VCM3); a T-Lens; a piezo motor drive; a Smooth Impact Drive Mechanism (SIDM); a liquid actuator; or a focusing motor in other form.

The CPU 100 may be further configured to obtain the registered image by shooting the object, or obtain the registered image transmitted by other device via a communication interface.

The CPU 100 may be further configured to perform an image processing for the image formed by the shooting.

In another embodiment, the image forming apparatus 700 and the CPU 100 may be configured separately. For example, the image forming apparatus 700 may be configured as a chip connected to the CPU 100, and the function of the image forming apparatus 700 is realized under the control of the CPU 100.

As illustrated in FIG. 8, the electronic device 800 may further include a communication module 110, an input unit 120, an audio processing unit 130, a camera 150, a display 160 and a power supply 170.

The CPU 100 (sometimes called as controller or operation control, including microprocessor or other processor device and/or logic device) receives an input and controls respective parts and operations of the electronic device 800. The input unit 120 provides an input to the CPU 100. The input unit 120 for example is a key or a touch input device. The camera 150 captures image data and supplies the captured image data to the CPU 100 for a conventional usage, such as storage, transmission, etc.

The power supply 170 supplies electric power to the electronic device 800. The display 160 displays objects such as images and texts. The display may be, but not limited to, an LCD.

The memory 140 may be a solid state memory, such as Read Only Memory (ROM), Random Access Memory (RAM), SIM card, etc., or a memory which stores information even if the power is off, which can be selectively erased and provided with more data, and the example of such a memory is sometimes called as EPROM, etc. The memory 140 also may be a certain device of another type. The memory 140 includes a buffer memory 141 (sometimes called as buffer). The memory 140 may include an application/function storage section 142 which stores application programs and function programs or performs the operation procedure of the electronic device 800 via the CPU 100.

The memory 140 may further include a data storage section 143 which stores data such as contacts, digital data, pictures, sounds and/or any other data used by the electronic device. A drive program storage section 144 of the memory 140 may include various drive programs of the electronic device for performing the communication function and/or other functions (e.g., message transfer application, address book application, etc.) of the electronic device.

The communication module 110 is a transmitter/receiver 110 which transmits and receives signals via an antenna 111. The communication module (transmitter/receiver) 110 is coupled to the CPU 100, so as to provide an input signal and receive an output signal, which may be the same as the situation of conventional mobile communication terminal.

Based on different communication technologies, the same electronic device may be provided with a plurality of communication modules 110, such as cellular network module, Bluetooth module and/or wireless local area network (WLAN) module. The communication module (transmitter/receiver) 110 is further coupled to a speaker 131 and a microphone 132 via an audio processor 130, so as to provide an audio output via the speaker 131, and receive an audio input from the microphone 132, thereby performing the normal telecom function. The audio processor 130 may include any suitable buffer, decoder, amplifier, etc. In addition, the audio processor 130 is further coupled to the CPU 100, so as to locally record sound through the microphone 132, and play the locally stored sound through the speaker 131.

The embodiment of the present invention further provides a computer readable program, which when being executed in an electronic device, enables a computer to perform the image forming method according to Embodiment 1 in the electronic device.

The embodiment of the present invention further provides a storage medium storing a computer readable program, wherein the computer readable program enables a computer to perform the image forming method according to Embodiment 1 in an electronic device.

The preferred embodiments of the present invention are described as above with reference to the drawings. Many features and advantages of those embodiments are apparent from the detailed Specification, thus the accompanied claims intend to cover all such features and advantages of those embodiments which fall within the spirit and scope thereof. In addition, since numerous modifications and changes are easily conceivable to a person skilled in the art, the embodiments of the present invention are not limited to the exact structures and operations as illustrated and described, but cover all suitable modifications and equivalents falling within the scope thereof.

It shall be understood that each of the parts of the present invention may be implemented by hardware, software, firmware, or combinations thereof. In the above embodiments, multiple steps or methods may be implemented by software or firmware stored in the memory and executed by an appropriate instruction executing system. For example, if the implementation uses hardware, it may be realized by any one of the following technologies known in the art or combinations thereof as in another embodiment: a discrete logic circuit having a logic gate circuit for realizing logic functions of data signals, application-specific integrated circuit having an appropriate combined logic gate circuit, a programmable gate array (PGA), and a field programmable gate array (FPGA), etc.

Any process, method or block in the flowchart or described in other manners herein may be understood as being indicative of including one or more modules, segments or parts for realizing the codes of executable instructions of the steps in specific logic functions or processes, and that the scope of the preferred embodiments of the present invention include other implementations, wherein the functions may be executed in manners different from those shown or discussed (e.g., according to the related functions in a substantially simultaneous manner or in a reverse order), which shall be understood by a person skilled in the art.

The logic and/or steps shown in the flowcharts or described in other manners here may be, for example, understood as a sequencing list of executable instructions for realizing logic functions, which may be implemented in any computer readable medium, for use by an instruction executing system, apparatus or device (such as a system based on a computer, a system including a processor, or other systems capable of extracting instructions from an instruction executing system, apparatus or device and executing the instructions), or for use in combination with the instruction executing system, apparatus or device.

The above literal descriptions and drawings show various features of the present invention. It shall be understood that a person of ordinary skill in the art may prepare suitable computer codes to carry out each of the steps and processes described above and illustrated in the drawings. It shall also be understood that the above-described terminals, computers, servers, and networks, etc. may be any type, and the computer codes may be prepared according to the disclosure contained herein to carry out the present invention by using the apparatus.

Particular embodiments of the present invention have been disclosed herein. A person skilled in the art will readily recognize that the present invention is applicable in other environments. In practice, there exist many embodiments and implementations. The appended claims are by no means intended to limit the scope of the present invention to the above particular embodiments. Furthermore, any reference to “an apparatus configured to . . . ” is an explanation of apparatus plus function for describing elements and claims, and it is not desired that any element using no reference to “an apparatus configured to . . . ” is understood as an element of apparatus plus function, even though the wording of “apparatus” is included in that claim.

Although a particular preferred embodiment or embodiments have been shown and the present invention has been described, it is obvious that equivalent modifications and variants are conceivable to a person skilled in the art in reading and understanding the description and drawings. Especially for various functions executed by the above elements (parts, components, apparatus, and compositions, etc.), except otherwise specified, it is desirable that the terms (including the reference to “apparatus”) describing these elements correspond to any element executing particular functions of these elements (i.e. functional equivalents), even though the element is different from that executing the function of an exemplary embodiment or embodiments illustrated in the present invention with respect to structure. Furthermore, although the a particular feature of the present invention is described with respect to only one or more of the illustrated embodiments, such a feature may be combined with one or more other features of other embodiments as desired and in consideration of advantageous aspects of any given or particular application.

1. An image forming method, comprising:
matching a real-time image formed by an image forming element with a pre-stored registered image, when a depth of field of the image forming element moves; and
making a shooting when an object corresponding to the registered image is matched with an object in the real-time image and the object is within the depth of field of the image forming element.

2. The method according to claim 1, wherein by using a focusing apparatus, the depth of field of the image forming element is controlled to move from near to far, or move to-and-fro between proximal and distal ends.

3. The method according to claim 1, wherein said making a shooting comprises shooting is a static image.

4. The method according to claim 1, further comprising obtaining the registered image by shooting the object.

5. The method according to claim 1, further comprising: performing an image processing for an image formed by the shooting.

6. The method according to claim 1, further comprising: giving an information prompt when an object corresponding to the registered image is not matched with the object in the real-time image.

7. An image forming apparatus, comprising:
an image matching unit configured to match a real-time image formed by an image forming element with a pre-stored registered image, when a depth of field of the image forming element moves; and
an image shooting unit configured to make a shooting when an object corresponding to the registered image is matched with an object in the real-time image and the object is within the depth of field of the image forming element.

8. The apparatus according to claim 7, further comprising:
an image registering unit configured to obtain the registered image by shooting the object.

9. The apparatus according to claim 7, further comprising:
an image processing unit configured to perform an image processing for an image formed by the shooting.

10. The apparatus according to claim 7, further comprising:
an information prompting unit configured to give an information prompt when an object corresponding to the registered image is not matched with the object in the real-time image.

11. An electronic device, comprising:
an image forming element having a depth of field;
a focusing apparatus configured to control the depth of field of the image forming element to move; and
the image forming apparatus according to claim 7.

12. The electronic device according to claim 11, wherein the focusing apparatus is configured to control the depth of field of the image forming element from near to far, or move to-and-fro between proximal and distal ends.

13. The electronic device according to claim 12, wherein the focusing apparatus comprises at least one of a Voice Coil Motor (VCM), a T-Lens, a piezo motor drive, a Smooth Impact Drive Mechanism (SIDM) or a liquid actuator.

14. The method according to claim 1, wherein said making a shooting comprises shooting a dynamic image.

15. The method according to claim 1, further comprising obtaining the registered image by obtaining the registered image transmitted from another device via a communication interface.

16. The apparatus according to claim 7, further comprising:
an image registering unit configured to obtain the registered image transmitted by another device via a communication interface.

17. An electronic device, comprising:
an image forming element having a depth of field;
a focusing apparatus configured to control the depth of field of the image forming element to move; and
the image forming apparatus according to claim 8.
